(19) United States
(12) Patent Application Publication
(10) Pub. No.: US 2026/0014839 A1
(43) Pub. Date: Jan. 15, 2026

(54) VEHICLE BODY STRUCTURE HAVING INTERCHANGEABLE PANELS

(71) Applicant: FORD GLOBAL TECHNOLOGIES, LLC, Dearborn, MI (US)

(72) Inventors: Steven Frank, Dearborn, MI (US); Adam Weyrauch, Canton, MI (US)

(21) Appl. No.: 18/767,452

(22) Filed: Jul. 9, 2024

(51) Int. Cl. B60J 5/04; B60J 1/16; B60J 5/10

(52) U.S. Cl. CPC B60J 5/0473; B60J 1/16; B60J 5/107

(57) ABSTRACT

A vehicle body includes an underlying framework and a plurality of exterior panels. The underlying framework has a rear-door region and a rear-side region. The plurality of exterior panels is secured to the underlying framework. The plurality of exterior panels includes one or more selectable and interchangeable panels secured to the rear-side region and the rear-door region. The selectable and interchangeable panels include a first panel and a second panel, or a third panel. In the first instance, the first panel is rotatably secured to the rear-door region and the second panel is secured to the rear-side region. In the second instance, the third panel is secured to each of the rear-door region and the rear-side region.

### TECHNICAL FIELD

The present disclosure relates to vehicle body structures and/or vehicle frame structures.

### BACKGROUND

Vehicles and automobiles include bodies and/or frames that operate as the underlying support structure for the other subsystems of the vehicle (e.g., powertrain systems, steering systems, etc.).

### SUMMARY

A vehicle includes a body framework, a hinge, and a plurality of panels. The body framework has a rearward side region. The hinge is secured to the rearward side region. The plurality of panels is secured to the body framework. The plurality of panels includes one or more interchangeable panels secured to the rearward side region. A first set of the interchangeable panels includes a door panel and a rear panel. The door panel is rotatably securable to the hinge along a first portion of the rearward side region such that the door panel is operable to rotate relative to the hinge. The rear panel is securable to a second portion of the rearward side region. A second set of the interchangeable panels includes an integrated panel rotatably securable to the hinge along the first portion of the rearward side region and rigidly securable to the second portion of the rearward side region such that rotation of the integrated panel about the hinge is inhibited.

A vehicle includes a body framework, a hinge, and a plurality of panels. The body framework has a rear-door region and a rear-side region. The rear-side region is adjacent to and rearward from the rear-door region. The hinge is secured to the rear-door region. The plurality of exterior panels is secured to the body framework, wherein the plurality of exterior panels includes one or more interchangeable panels secured to the rear-side region and the rear-door region. The interchangeable panels include a first panel having a forward region rotatably secured to the hinge and a rearward region secured to the rear-side region such that first panel is inhibited from rotating about the hinge.

A vehicle body includes an underlying framework and a plurality of exterior panels. The underlying framework has a rear-door region and a rear-side region. The plurality of exterior panels is secured to the underlying framework. The plurality of exterior panels includes one or more selectable and interchangeable panels secured to the rear-side region and the rear-door region. The selectable and interchangeable panels include a first panel and a second panel, or a third panel. In the first instance, the first panel is rotatably secured to the rear-door region, the second panel is distinct from the first panel, and the second panel is secured to the rear-side region. In the second instance, the third panel is secured to each of the rear-door region and the rear-side region.

### BRIEF DESCRIPTION OF THE DRAWINGS

FIG. 1 is a perspective side view of a portion of a vehicle including a vehicle body structure;

FIG. 2 is a perspective front view of a first configuration of one or more panels that form the rear side portion of the vehicle body structure;

FIG. 3 is a perspective rear view of the first configuration of one or more panels that form the rear side portion of the vehicle body structure;

FIG. 4 is a perspective front view of a second configuration of the one or more panels that form the rear side portion of the vehicle body structure;

FIG. 5 is a perspective rear view of the second configuration of the one or more panels that form the rear side portion of the vehicle body structure;

FIG. 6 is a cross-sectional view taken along line 6-6 in FIG. 1; and

FIG. 7 is a perspective view illustrating an attachment between the one or more panels and a door hinge.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

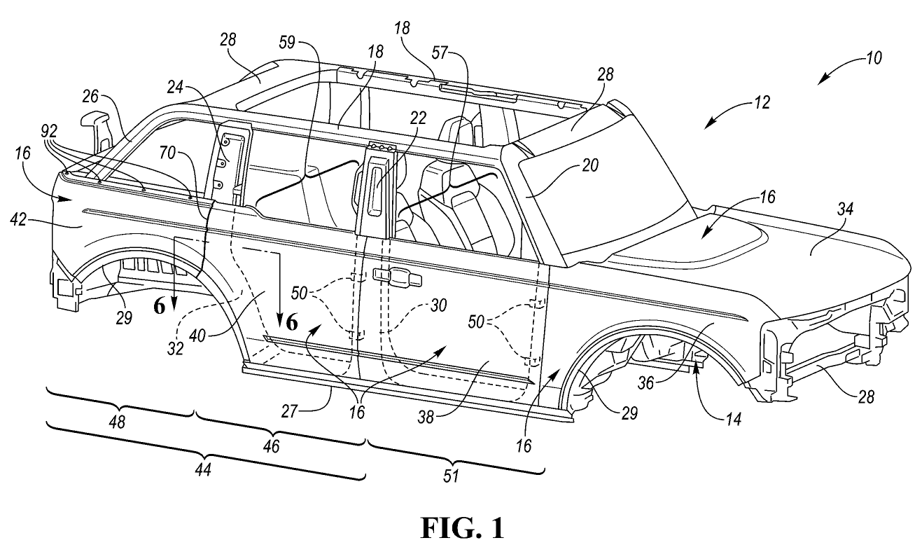

Referring to FIG. 1 a perspective side view of a portion of a vehicle 10 and a corresponding vehicle body structure 12 of the vehicle 10 is illustrated. The vehicle body structure 12 may simply be referred to as the vehicle body. The vehicle body structure 12 includes an underlying body framework 14 and a plurality of exterior panels 16 that are secured to the underlying body framework 14.

The underlying body framework 14 may include roof rails 18, A-pillars 20, B-pillars 22, C-pillars 24, D-pillars 26, rocker panels 27, cross members 28, floor members, floor panels, shocks towers, front rails, rear rails, or any other structural component that forms a portion of the underlying body framework 14 of the vehicle body structure 12. The components or subcomponents of the underlying body framework 14 may also form wheel wells 29, front door frames 30, and rear door frames 32. The image in FIG. 1 is illustrative of common vehicle body components or subcomponents. The specific shape and structure of the vehicle body 10 is not intended to be limiting. Other vehicle body structure configurations should be construed as encompassed herein. For example, some vehicle body structures may not include a D-pillars 26.

The plurality of exterior panels 16 may include a hood panel 34, front fender panels 36, front door panel 38, rear door panels 40, rear fender panels 42, roof panels, floor panels, bottom panels, hatch door or tailgate panels, or any other panel that forms a portion of the plurality of exterior panels 16 of the vehicle body structure 12. The front fender panels 36 may be referred to as the front panels. The rear fender panels 42 may be referred to as the rear panels.

The underlying body framework 14 has a rearward side region 44. More generally, the rearward side region 44 may be a rearward side region of the vehicle 10 or the vehicle body structure 12. The underlying body framework 14 may also have a rear-door region 46 and a rear-side region 48. More generally, the rear-door region 46 and the rear-side region 48 may be a rear-door region and a rear-side region of the vehicle 10 or the vehicle body structure 12. The rear-door region 46 and the rear-side region 48 may be sub-regions within the rearward side region 44. The rear-side region 48 may be adjacent to and rearward from the rear-door region 46 along the vehicle 10 or the vehicle body structure 12.

Hinges 50 may be secured to the underlying body framework 14. The hinges 50 may be operable to rotatably secure the front door panels 38 to a front-door region 51 of the underlying body framework 14. More specifically, the front door panels 38 may be secured to the front door frames 30 via the hinges 50. More generally, the front-door region 51 may be a front-door region of the vehicle 10 or the vehicle body structure 12. Additional hinges 50 may be operable to rotatably secure the rear door panels 40 to the rearward side region 44, or more specifically the rear-door region 46, of the underlying body framework 14. More specifically, the rear door panels 40 may be secured to the rear door frames 32 via the hinges 50. The front door panels 38 and the rear door panels 40 may be secured to internal structural support frames or door structural support frames, and the hinges 50 may more specifically be secured to such internal structural support frames or door structural support frames.

The subcomponents of the vehicle body structure 12, including the underlying body framework 14 and the plurality of exterior panels 16, may be secured to each other via fasteners (e.g., screws, rivets, bolts, etc.), adhesives, welding, or any other method known in the art. The subcomponents of the vehicle body structure 12 may be made from steel, aluminum, magnesium, titanium, or any other material that may operate as a support structure for the other components and subsystems of the vehicle 10.

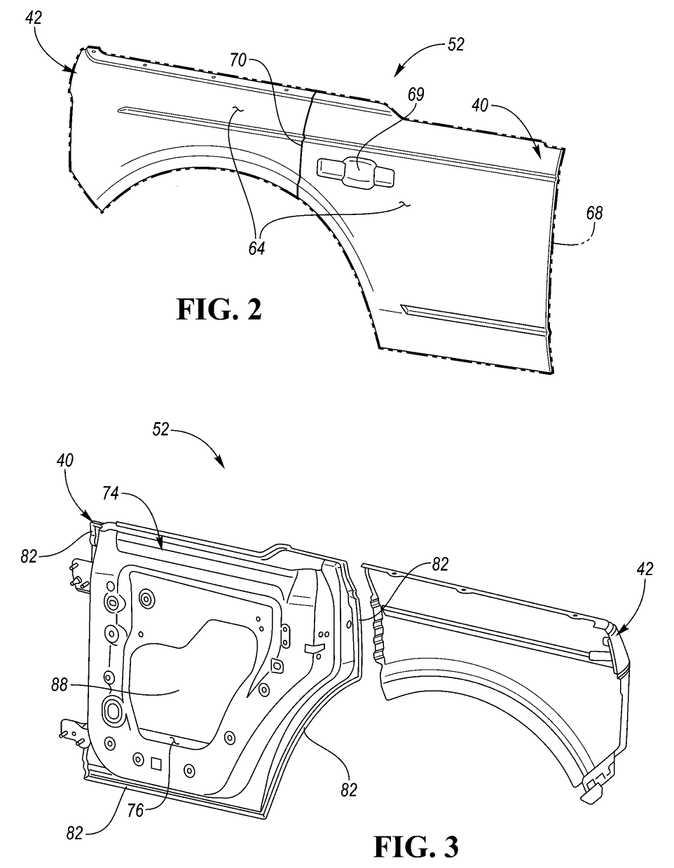

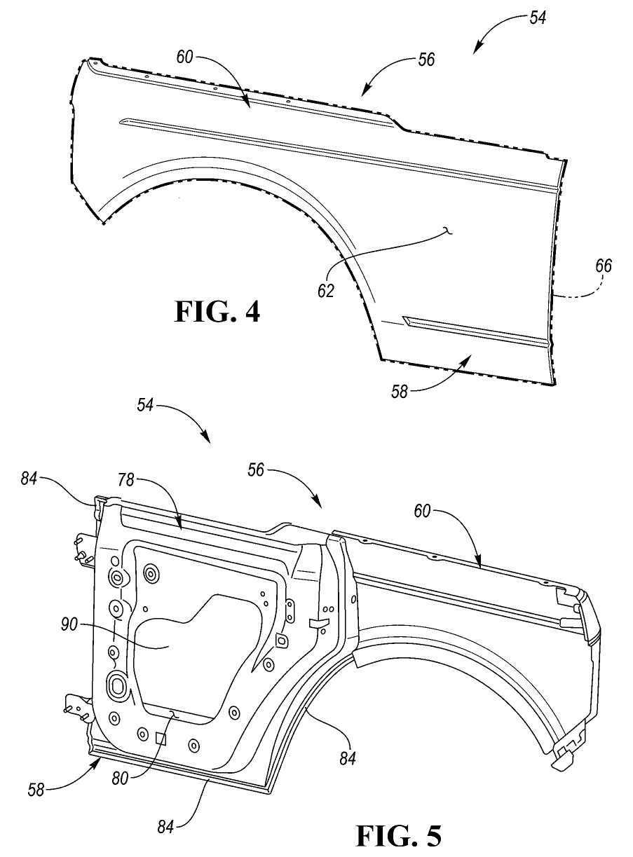

Referring to FIGS. 2-5, several configurations of one or more panels (e.g., the rear door panels 40 and rear fender panels 42) that form the rear side portion of the vehicle body structure 12 are illustrated. The plurality of exterior panels 16 may include one or more selectable and interchangeable panels that are secured to the rearward side region 44, or more specifically to the rear-door region 46 and the rear-side region 48.

A first set 52 (e.g., FIG. 2) of the one or more selectable and interchangeable panels may include one of the rear door panels 40 and one of the rear fender panels 42, where the rear door panel 40 is rotatably securable to one or more of the hinges 50 along a first portion (e.g., rear-door region 46) of the rearward side region 44 of the underlying body framework 14 such that the rear door panel 40 is operable to rotate relative to the one or more hinges 50, and where rear fender panel 42 is securable to a second portion (e.g., rear-side region 48) of the rearward side region 44 of the underlying body framework 14. The rear door panel 40 and rear fender panel 42 are separate and distinct from each other in the first set 52 of the one or more selectable and interchangeable panels.

A second set 54 (e.g., FIG. 3) of the one or more selectable and interchangeable panels may include an integrated panel 56 that is secured to rearward side region 44 of the underlying body framework 14, including the of rear-door region 46 and the rear-side region 48 of the underlying body framework 14. More specifically, a first or forward region 58 of the integrated panel 56 may be rotatably securable to the one or more hinges 50 along the first portion (e.g., rear-door region 46) of the rearward side region 44 and a second or rearward region 60 of the integrated panel 56 may be securable to the second portion (e.g., rear-side region 48) of the rearward side region 44 such that rotation of the integrated panel 56 about the one or more hinges is prevented or inhibited. More specifically, the rearward region 60 of the integrated panel 56 may be securable to the second portion (e.g., rear-side region 48) of the rearward side region 44 in a rigid or fix manner.

The integrated panel 56 is meant to occupy the same space on the underlying body framework 14 as the rear door panel 40 and the rear fender panel 42. Therefore, the integrated panel 56 could be represented in FIG. 1 as a combination of the rear door panel 40 and the rear fender panel 42 by removing the gap 70 that that is currently depicted between the rear door panel 40 and rear fender panel 42 in FIG. 1.

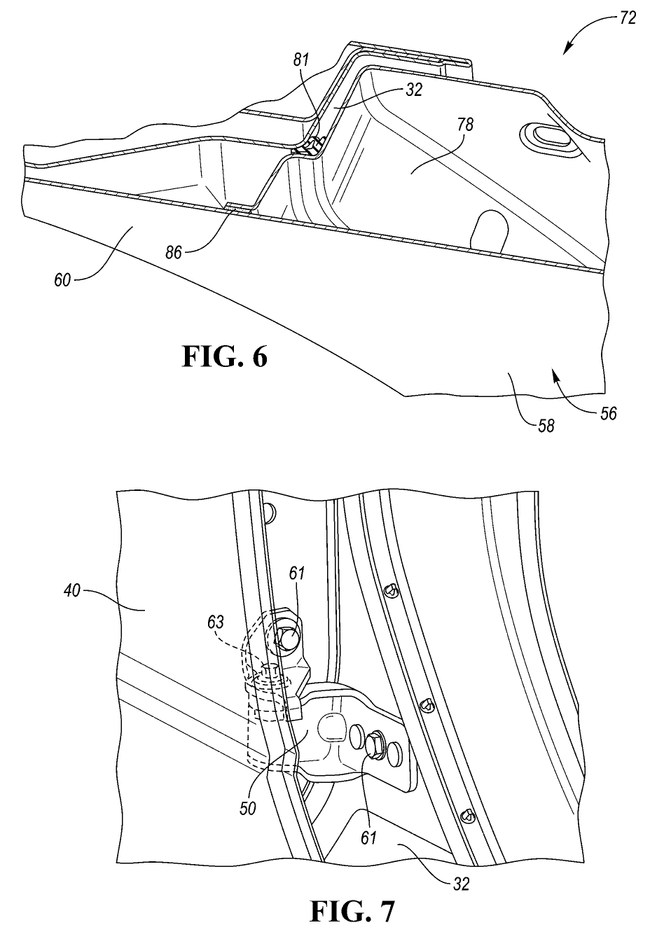

It is noted that the integrated panel 56 is illustrated in FIG. 6. It is also noted that the rear door panel 40 is illustrated in FIG. 7. However, it should be understood that the rear door panel 40 and the rear fender panel 42 may be represented in FIG. 6 by adding the gap 70 that is between the rear door panel 40 and rear fender panel 42, deleting callout number 56, changing callout number 58 to callout number 40, and changing callout number 60 to callout number 42. It should also be understood that the integrated panel 56 may be illustrated in FIG. 7 by changing callout number 40 to callout number 56.

The rear door panel 40 and the integrated panel 56 may each be attached to the hinges 50 via fasteners 61 (e.g., screws, rivets, bolts, etc.). The hinges 50 may also be attached the rear door frame 32 via fasteners 61. The hinges 50 may each include two portions that are rotatable relative to each other where the two portions of the hinges 50 are connected to each other via a pin 63 that allows for relative rotation between the two portions of the hinges 50.

An exterior surface area 62 of the integrated panel 56 is substantially the same as a combined exterior surface area 64 of the rear door panel 40 and rear fender panel 42. An outer boundary or periphery 66 of the integrated panel 56 is also substantially the same as a combined outer boundary or periphery 68 of the rear door panel 40 and rear fender panel 42 (e.g., outer periphery 66 and outer periphery 68 may cover the same overall distance, may have the same overall length, may have the same shape, may cover the same spatial area over the underlying body framework 14, etc.). The integrated panel 56 is interchangeable with the door panel 40 and rear fender panel 42 so that the vehicle 10 may be changeable between a four-door vehicle (e.g., when the door panel 40 and rear fender panel 42 are secured to the underlying body framework 14) and a two-door vehicle (e.g., when the integrated panel 56 is secured to the underlying body framework 14). The integrated panel 56, therefore, is meant to occupy the same space on the vehicle body structure 12. The exterior surface of the rear door panel 40 may include a recessed region 69 that is operable to receive a door handle while the integrated panel 56 does not include such a recessed region 69.

The vehicle 10 may include a first row 57 and a second row 59, generally. The second row 59 may be selectably configured, for example to accommodate either large cargo or vehicle occupants as desired.

The substantially same values of the exterior surface area 62 of the integrated panel 56 and the combined exterior surface area 64 of the rear door panel 40 and rear fender panel 42 may differ slightly to account for the small gap 70 that that is between the rear door panel 40 and rear fender panel 42. The substantially same values of the exterior surface area 62 of the integrated panel 56 and the combined exterior surface area 64 of the rear door panel 40 and rear fender panel 42 may between 100 mm² or less and zero from having exactly the same exterior surfaces areas.

The substantially same values of the outer periphery 66 of the integrated panel 56 and the combined outer periphery 68 of the rear door panel 40 and rear fender panel 42 of the rear door panel 40 and rear fender panel 42 may differ slightly to account for breaks in the combined outer periphery 68 due to the small gap 70 that that is between the rear door panel 40 and rear fender panel 42. The substantially same values of the overall length of the outer periphery 66 of the integrated panel 56 and the overall length of the combined outer periphery 68 of the rear door panel 40 and rear fender panel 42 may between 10 mm or less and zero from having exactly the same overall lengths.

As previously stated, the front door panels 38 and the rear door panels 40 may be secured to internal structural support frames or door structural support frames, and the hinges 50 may more specifically be secured to such internal structural support frames or door structural support frames. Also, the integrated panel 56 may be secured to an internal structural support frame or door structural support frames so that the interface 72 between the integrated panel 56 and the rear door frame 32 is the same as the interface 72 between the rear door panel 40 and the rear door frame 32 (i.e., both the integrated panel 56 and the rear door panel 40 have the same internal shape are operable to attach to the rear door frame 32 in the same manner). The internal structural support frames or door structural support frames may include a first internal structural support frame 74 that is secured to an internal surface 76 of the rear door panel 40 and a second internal structural support frame 78 that is secured to an internal surface 80 of the integrated panel 56. Each of the first internal structural support frame 74 and the second internal structural support frame 78 may also include common seals 81 (e.g., rubber seals) that engage the rear door frame 32 to prevent the leakage of fluids between either the first internal structural support frame 74 or the second internal structural support frame 78 and the rear door frame 32.

The rear door panel 40 may include hems 82 that operate to secure the first internal structural support frame 74 to the rear door panel 40. The hems 82 may extend along four of five sides of the rear door panel 40 and the first internal structural support frame 74. The integrated panel 56 may also include hems 84 that secure the second internal structural support frame 78 to the integrated panel 56. However, the hems 84 only extend along three of the five sides of the integrated panel 56 and the second internal structural support frame 78. Due to the extension on the integrated panel 56 (e.g.., rearward region 60 of the integrated panel 56), a hem is not available to attach the fourth side of the of the integrated panel 56 and to the fourth side of second internal structural support frame 78. An adhesive 86 may be utilized along the fourth side of the integrated panel 56 and the second internal structural support frame 78 to attach the fourth side of the integrated panel 56 and the second internal structural support frame 78 to each other.

A first window 88 may be slidably secured to the first internal structural support frame 74. A corresponding sliding mechanism (e.g., tracks or guides that guide the first window 88 up and down between opened and closed positions, an actuator, such as a motor, that provides the power to slide the first window 88 up and down, etc.) may also be secured to the first internal structural support frame 74. A second window 90 may be slidably secured to the second internal structural support frame 78. A corresponding sliding mechanism (e.g., tracks or guides that guide the second window 90 up and down between opened and closed positions, an actuator, such as a motor, that provides the power to slide the second window 90 up and down, etc.) may also be secured to the second internal structural support frame 78. The actuators, which operate to adjust the first window 88 and second window 90 between the opened and closed positions, may receive power from a power source, such as a battery, and may be controlled by a controller.

Such a controller may be part of a larger control system and may be controlled by various other controllers throughout the vehicle 10, such as a vehicle system controller (VSC). It should therefore be understood that the controller and one or more other controllers can collectively be referred to as a “controller” that controls various actuators in response to signals from various sensors to control functions the vehicle 10 or vehicle subsystems. The controller may include a microprocessor or central processing unit (CPU) in communication with various types of computer readable storage devices or media (e.g., a non-transitory computer readable medium having instructions stored thereon). Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle 10 or vehicle subsystems.

Control logic or functions performed by the controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used.

Similarly, the order of processing is not necessarily required to achieve the features and advantages described herein, but is provided for ease of illustration and description. The control logic may be implemented primarily in software executed by a microprocessor-based window or vehicle controller, such as controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The integrated panel 56 is secured to the underlying body framework 14 in the same manner as the rear door panel 40 and the rear fender panels 42. This allows for a quick and simple change between a two-door configuration and a four-door configuration. An additional benefit is that each are attachable to the same underlying body framework 14, which simplifies manufacturing.

The common attachment system utilized by the integrated panel 56 and the combination of the rear door panel 40 and the rear fender panel 42 includes (i) either attaching the the forward region 58 of the integrated panel 56 or the rear door panel 40 to the one or more hinges 50 along the first portion (e.g., rear-door region 46) of the rearward side region 44 and (ii) either attaching the rearward region 60 of the integrated panel 56 or the rear fender panel 42 to the second portion (e.g., rear-side region 48) of the rearward side region 44 of the underlying body framework 14. More specifically, fasteners 92 (e.g., See FIG. 1) may engage either an upper edge of the rearward region 60 of the integrated panel 56 or an upper edge the rear fender panel 42, and may engage the underlying body framework 14, to either secure the rearward region 60 of the integrated panel 56 or the rear fender panel 42 to the underlying body framework 14.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a body framework having a rearward side region;
a hinge secured to the rearward side region; and
a plurality of panels secured to the body framework, wherein the plurality of panels includes one or more interchangeable panels secured to the rearward side region, wherein a first set of the interchangeable panels includes (i) a door panel rotatably securable to the hinge along a first portion of the rearward side region such that the door panel is operable to rotate relative to the hinge and (ii) a rear panel securable to a second portion of the rearward side region, and wherein a second set of the interchangeable panels includes an integrated panel (i) rotatably securable to the hinge along the first portion of the rearward side region and (ii) rigidly securable to the second portion of the rearward side region such that rotation of the integrated panel about the hinge is inhibited.

2. The vehicle of claim 1, wherein an exterior surface area of the integrated panel is substantially the same as a combined exterior surface area of the door panel and the rear panel.

3. The vehicle of claim 1, wherein an outer periphery of the integrated panel is substantially the same as a combined outer periphery of the door panel and the rear panel.

4. The vehicle of claim 1, further comprising a first structural support frame secured to an internal surface of the door panel.

5. The vehicle of claim 4, further comprising a second structural support frame secured to an internal surface of the integrated panel.

6. The vehicle of claim 5, further comprising a first window slidably secured to the first structural support frame.

7. The vehicle of claim 6, further comprising a second window slidably secured to the second structural support frame.

8. A vehicle comprising:
a body framework having a rear-door region and a rear-side region, wherein the rear-side region is adjacent to and rearward from the rear-door region;
a hinge secured to the rear-door region; and
a plurality of exterior panels secured to the body framework, wherein the plurality of exterior panels includes one or more interchangeable panels secured to the rear-side region and the rear-door region, wherein the interchangeable panels include a first panel having (i) a forward region rotatably secured to the hinge and (ii) a rearward region secured to the rear-side region such that first panel is inhibited from rotating about the hinge.

9. The vehicle of claim 8, wherein the interchangeable panels include a second panel that is rotatably secured to the hinge along rear-door region such that the second panel is operable to rotate relative to the hinge and a third panel that is secured to the rear-side region.

10. The vehicle of claim 9, wherein an outer periphery of the first panel is substantially the same as a combined outer periphery of the second panel and the third panel.

11. The vehicle of claim 9, wherein an exterior surface area of the first panel is substantially the same as a combined exterior surface area of the second panel and the third panel.

12. The vehicle of claim 9, further comprising a first structural support frame secured to an internal surface of the first panel along the forward region.

13. The vehicle of claim 12, further comprising a second structural support frame secured to an internal surface of the second panel.

14. A vehicle body comprising:
an underlying framework having a rear-door region and a rear-side region; and
a plurality of exterior panels secured to the underlying framework, wherein the plurality of exterior panels includes one or more selectable and interchangeable panels secured to the rear-side region and the rear-door region, wherein the selectable and interchangeable panels include,
a first panel rotatably secured to the rear-door region and a second panel distinct from the first panel and secured to the rear-side region, or
a third panel secured to each of the rear-door region and the rear-side region.

15. The vehicle body of claim 14, further comprising a hinge secured to the rear-door region of the underlying framework.

16. The vehicle body of claim 15, wherein the third panel is rotatably secured to the rear-door region via the hinge.

17. The vehicle body of claim 16, wherein the third panel is secured to the rear-side region such that first panel is inhibited from rotating about the hinge.

18. The vehicle body of claim 17, wherein the rear-side region is adjacent to the rear-door region.

19. The vehicle body of claim 14, wherein an outer periphery of the third panel is substantially the same as a combined outer periphery of the first panel and the second panel.

20. The vehicle body of claim 14, wherein an exterior surface area of the third panel is substantially the same as a combined exterior surface area of the first panel and the second panel.
